(19) United States
(12) Patent Application Publication
(10) Pub. No.: US 2007/0030161 A1
(43) Pub. Date: Feb. 8, 2007

(54) COMMUNICATIONS SYSTEM AND METHOD CAPABLE OF GENERATING WIRELESS SIGNALS ACCORDING TO A STATUS OF AN ELECTRIC APPLIANCE

(76) Inventor: Tzung-Yuan Yang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/462,995

(22) Filed: Aug. 7, 2006

(30) Foreign Application Priority Data
Aug. 8, 2005 (TW) 094126832

(51) Int. Cl. G08B 21/00

(52) U.S. Cl. 340/679

(57) ABSTRACT

A communications system and method capable of generating wireless signals according to the status of an electric appliance incorporates an intelligent communications device. The communications system transmits radio signals to a first user when an electric appliance reaches a dangerous state until receiving an acknowledgement signal from the first user. If no acknowledgement signal is received within a predetermined time, the communications system transmits radio signals to a second user until receiving an acknowledgement signal from the second user to prevent possible accident caused by the electric appliance.

### BACKGROUND OF THE INVENTION

1. Field of the Invention

The present invention relates to a communications system, and more specifically, to a communications system capable of generating wireless signals according to a status of an electric appliance.

2. Description of the Prior Art

The popularization of household appliances and the automation of housework have allowed most manual housework, including some dangerous work, to be done by various household appliances. Hence, many household appliances, such as gas hot plates, water boilers, irons, or electric radiators, are equipped with safety devices to fully protect the appliances and their users. Other household appliances are equipped with digital timers that can deactivate the appliance after the appliance has been working for a certain time. For example, many water boilers on the market have a safety device that automatically powers off the water boiler within 20 minutes of being turned on.

Unfortunately, these household appliances may not work properly after the safety device has gone off. When a safety issue happens, if no one takes the time to inspect the safety device or the household appliance as a whole, damage to the device may go undetected. This can lead to future hazardous situations.

In addition, if an elderly, a toddler, or a disabled family member discovers an emergency caused by a household appliance, they may not be capable of dealing with the emergency themselves. They also may not be capable of informing someone else. Such an emergency can be life threatening. Therefore, a household safety alarm system that can inform people who can fully handle an emergency is needed.

### SUMMARY OF THE INVENTION

Therefore, the primary objective of the claimed invention is to provide a communications system capable of generating wireless signals according to a status of an electric appliance to solve the above problem.

The claimed invention provides a communications system capable of generating wireless signals according to a status of an electric appliance, comprising a detector for detecting the status of the electric appliance; a processor coupled with the detector for generating a warning signal; a signal converter coupled with the processor for modulating the warning signal generated by the processor and generating a wireless signal; and a communications module coupled with the signal converter for transmitting the wireless signal; wherein when the detector detects the status of the electric appliance being a predetermined status, the processor generates the warning signal for the signal converter to modulate into a wireless signal for being transmitted by the communications module.

The claimed invention also provides a method for generating a first wireless signal according to a status of an electric appliance, the method comprising (a) detecting the status of the electric appliance; (b) generating a first warning signal when detecting the status of the electric appliance as a predetermined status; (c) modulating the first warning signal generated in step (b) to generate the first wireless signal; and (d) transmitting the first wireless signal generated in step (c).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are illustrations of a present invention communications system.

FIG. 4 and FIG. 5 are flow charts according to a method capable of generating wireless signals according to a status of an electric appliance.

### DETAILED DESCRIPTION

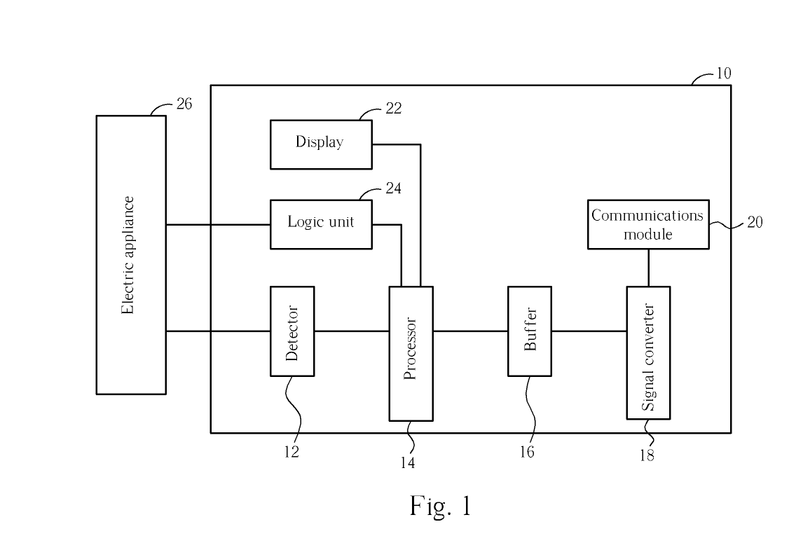

Please refer to FIG. 1, which is an illustration of a present invention communications system 10. The communications system 10 comprises a detector 12, a processor 14, a signal converter 18, and a communications module 20. The detector 12 is for detecting a status of an electric appliance 26. The processor 14 is coupled with the detector 12 for generating a warning signal when the detector 12 detects the status of the electric appliance 26 as a predetermined status. The signal converter 18 is coupled with the processor 14 for modulating the warning signal generated by the processor 14 and generating a wireless signal, which is then transmitted by the communications module 20. The communications module 20 is coupled with the signal converter 18 and is capable of receiving a wireless signal and transmitting the received wireless signal to the signal converter 18. The present invention transmits signals in a wireless form, where the wireless signals can be bluetooth signals, RF signals, or wireless network.

Additionally, the communications system 10 further comprises a display 22, a buffer 16, and a logic unit 24. The display 22 is coupled with the processor 14 for displaying the status of the electric appliance 26. The display 22 can also be separately installed on the electric appliance 26, connecting with the communications system 10 through a connection port and corresponding circuit. The content to be displayed on the display 22 can be data detected by the detector 12, the warning signal generated by the processor 14, a transmission status of the warning signal through the communications module 20, a receiving status from a wireless signal receiver, or a follow-up handling status. The buffer 16 is coupled between the processor 14 and the signal converter 18. When the detector 12 detects a predetermined status of the electric appliance 26 and the processor 14 generates the warning signal, the warning signal is sent to the buffer 16 for temporary storing. The warning signal is then sent to the signal converter 18 for generating a wireless signal and for being transmitted by the communications module 20. In addition, when the communications module 20 receives a wireless signal from outside and transmits the wireless signal to the signal converter 18 to generate a digital signal, the digital signal is sent to the buffer for temporary storage and then sent to the processor 14 for a follow-up processing. The logic unit 24 is coupled with the processor 14 for deactivating the electric appliance 26 when the electric appliance 26 enters a predetermined status. Just like how the display 22 is implemented in the system, the logic unit 24 can also be separately installed on the electric appliance 26 by connecting with the communications system 10 through a connection port and corresponding circuit. The logic unit 24 can also be a safety switch or any switch with similar function that can achieve the purpose of deactivating the electric appliance 26. In summary, the processor 14 of the communications system 10 generates a warning signal when the detector 12 detects a predetermined status of the electric appliance 26 and controls a switch of the electric appliance 26 to stop the electric appliance 26.

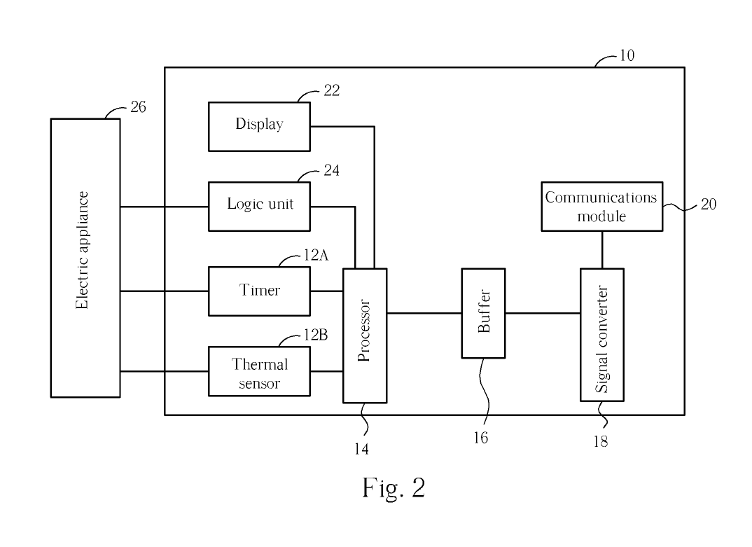

Please refer to FIG. 2 for an exemplary embodiment of the present invention communications system 10, wherein the electric appliance 26 can be a water boiler, an iron, or an electric radiator. There can be different arrangements of the detector 12 in the communications system 10 when applied on different electric appliances 26. Generally, more than one detector 12 can be installed in the communications system 10. These can be detectors such as a timer 12A and a thermal sensor 12B for detecting different status types of the electric appliance 26. The timer 12A is for measuring a working time of the electric appliance 26, and the thermal sensor 12B is for detecting temperature of the electric appliance 26. When the working time of the electric appliance 26 measured by the timer 12A exceeds a predetermined time or the temperature of the electric appliance 26 detected by the thermal sensor 12B exceeds a predetermined temperature, the electric appliance 26 enters the predetermined status. As stated above, the processor 14 then generate a warning signal while the logic unit 24 deactivates the electric appliance 26.

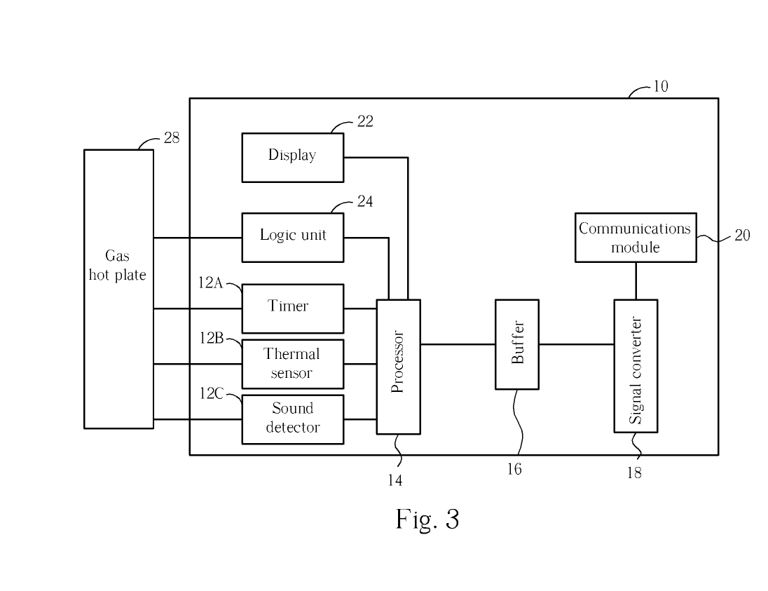

Please refer to FIG. 3 for a preferred exemplary embodiment of the present invention communications system 10. The communications system 10 can be applied to a gas heater 28. Different from the exemplary embodiment in FIG. 2, The communications system 10 in FIG. 3 further comprises a sound detector 12C for detecting sound from the gas hot plate 28. When the processor 14 compares the sound generated by the gas hot plate 28 with a pre-recorded sound sample and determines a match, as stated above, the gas hot plate 28 enters the predetermined status and the processor 14 generates a warning signal while the logic unit 24 deactivates the gas hot plate 28. Therefore, any one of the timer 12A, the thermal sensor 12B, and the sound detector 12C can be used to obtain the status of the gas hot plate 28 of the exemplary embodiment in FIG. 3, and the processor 14 can determine whether to enter the predetermined status or not. The timer 12A, the thermal sensor 12B, and the sound detector 12C are implementations of the detector 12 described above.

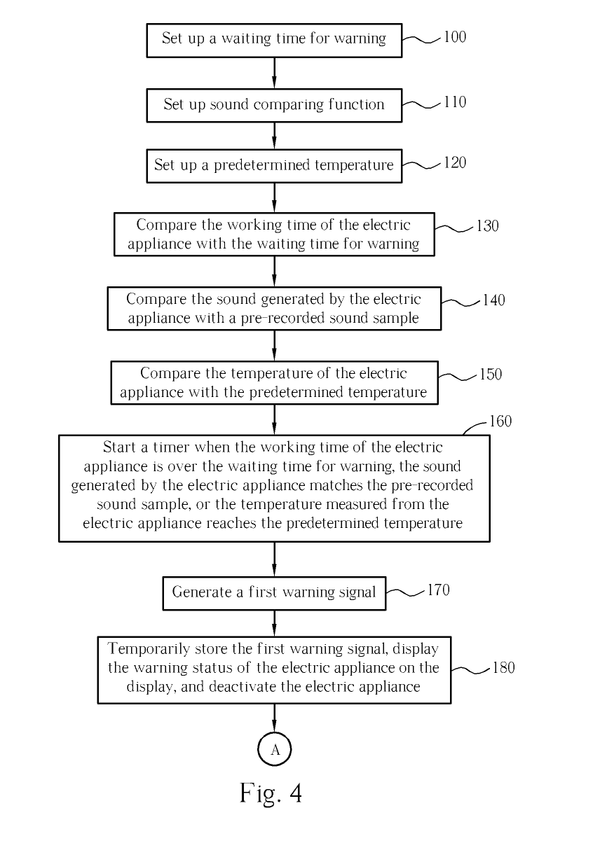

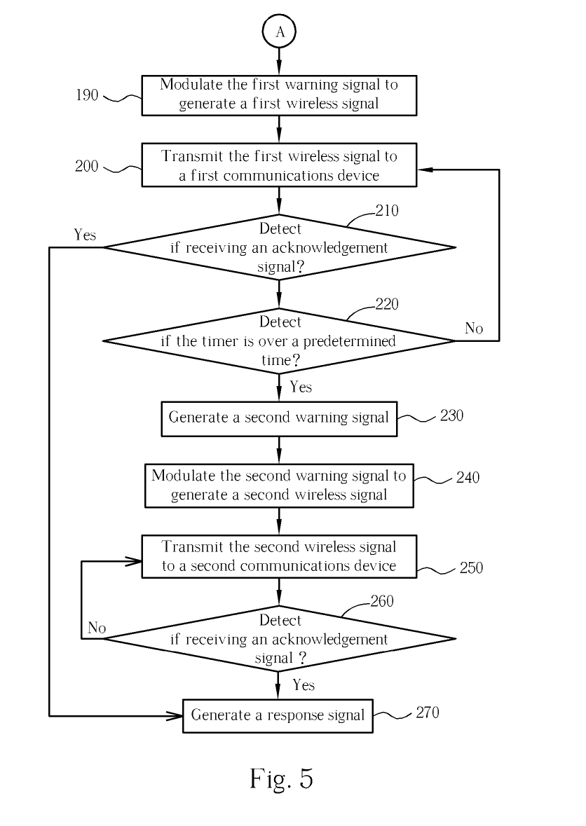

Please refer to FIG. 4 and FIG. 5, which are flow charts according to a method capable of generating wireless signals according to a status of an electric appliance 26. The steps are as followed:

Step 100: set up a waiting time for warning of the electric appliance 26;

Step 110: select a pre-recorded sound sample and set up a sound comparing function of the electric appliance 26;

Step 120: set up a predetermined temperature;

Step 130: compare the working time of the electric appliance 26 with the waiting time for warning;

Step 140: compare the sound generated by the electric appliance 26 with the pre-recorded sound sample;

Step 150: compare the temperature of the electric appliance 26 with the predetermined temperature;

Step 160: start a timer when the working time of the electric appliance 26 is over the waiting time for warning, the sound generated by the electric appliance 26 matches the pre-recorded sound sample, or the temperature measured from the electric appliance 26 reaches the predetermined temperature;

Step 170: generate a first warning signal;

Step 180: temporarily store the first warning signal generated in Step 170, display the warning status of the electric appliance 26 on the display 22, and deactivate the electric appliance 26;

Step 190: modulate the first warning signal generated in Step 170 to generate a first wireless signal;

Step 200: transmit the first wireless signal generated in Step 190 to a first communications device;

Step 210: detect if receiving an acknowledgement signal; if detected, proceed to Step 270;

Step 220: detect if the timer in Step 160 is over a predetermined time; if not detected, proceed to Step 200;

Step 230: generate a second warning signal;

Step 240: modulate the second warning signal generated in Step 230 to generate a second wireless signal;

Step 250: transmit the second wireless signal generated in Step 240 to a second communications device;

Step 260: detect if receiving an acknowledgement signal; if not detected, proceed to Step 250;

Step 270: generate a response signal.

In Steps 100˜120, when the electric appliance starts detection provided by the present invention communications system according to a user setup, the present invention communications system will provide three detection functions including time setup, sound comparison, and thermal detection. A user can set up one or two of the detection functions or set up all according to the specific need. The sequence of Steps 100˜120 described above is just for explanation, and is not limited to one particular order in practical application. The user can arbitrarily activate any one of the three detection functions in any order.

When the user finishes setting up the detection functions, the communications system of the present invention then works normally. During the working period of the electric appliance, the detectors obtain the detected data and determine whether the electric appliance has entered the predetermined status or not. Likewise, the sequence of Steps 130˜150 described above is just for explanation, and is not limited to one particular order in practical application. The communications system can have the detected result compared in any order according to the user's setup.

In Step 200, the communications system transmits the first warning signal as a wireless signal by its communications module to a first communications device. The presentation when the first communications device receives the first wireless signal can be a short message, an incoming call, a voice warning, or an interruption to a connected call, or any other way of notification that makes the user immediately aware of the warning signal. If the user responds with an acknowledgement signal within a predetermined time after receiving the first warning signal, the communications system then stops generating the first warning signal and generates a response signal and the procedure of safety notification of the present invention is finished. To consider a safer way, the communications system of the present invention accepts only an acknowledgement signal in the form of a manual button-pressing on the electric appliance by the user. However, the convenience for the user also needs to be considered, so the communications system can also accept a wireless signal transmitted from the communications device as the acknowledgement signal. When the communications system successfully receives the acknowledgement signal from the user, the communications system will transmit a wireless response signal to the user for confirmation.

As described before, if the user in Step 220 does not transmit an acknowledgement signal to the communications system within the predetermined time, the communications system will then consider that the person it sent the warning signal to cannot handle the emergency. Then as described in Step 240 and Step 250, the communications system will generate a second warning signal, modulate the second warning signal into a second wireless signal, and transmit the second wireless signal to a second communications device. The second communications device can be a mobile phone, a telephone, or other communications device. An exemplary embodiment of the present invention establishes a community security announcement system (CSAS). Through the CSAS the second warning signal can be delivered to the head of the community, the police, or family members who can effectively deal with the emergency situation. Like the verification procedure applied to the first communications device, the communications system can accept only an acknowledgement signal in the form of a manual button-pressing on the electric appliance by a second user or by a wireless signal transmitted from the second communications device as the acknowledgement signal.

The first warning signal generated in Step 170 includes an ID of the first communications device, and therefore the first wireless signal in Step 200 is transmitted to the first communications device. Likewise, the second warning signal generated in Step 230 includes an ID of the second communications device, and therefore the second wireless signal in Step 250 is transmitted to the second communications device. Even so, the second warning signal can include not just the ID of the second communications device, but also the ID of the first communications device, and even an ID of other communications devices for fulfilling simultaneous notification of the security situation to a plurality of communications devices.

Another exemplary embodiment of the present invention allows the first communications device to forward the warning signal to other communications devices.

In the communications system of the present invention, the communications module 20 can be a Bluetooth module or any similar type of short-range wireless communications module. The intelligent Bluetooth communications module along with the communications system of the present invention can establish a safety system for using electric appliances. The communications system of the present invention can effectively prevent fires or other emergencies due to the misuse of electric appliances or human carelessness. In addition, the communications system of the present invention can further prevent possible dangers caused by elderly, very-young, or handicapped users of electric appliances.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communications system capable of generating wireless signals according to a status of an electric appliance, comprising:
a detector for detecting the status of the electric appliance;
a processor coupled with the detector for generating a warning signal;
a signal converter coupled with the processor for modulating the warning signal generated by the processor and generating a wireless signal; and
a communications module coupled with the signal converter for transmitting the wireless signal;
wherein when the detector detects the status of the electric appliance being a predetermined status, the processor generates the warning signal for the signal converter to modulate into a wireless signal for being transmitted by the communications module.

2. The communications system of claim 1 further comprising a display installed on the electric appliance for displaying the status of the electric appliance.

3. The communications system of claim 1 further comprising a buffer coupled between the processor and the signal converter for temporarily storing the warning signal generated by the processor.

4. The communications system of claim 1 further comprising a logic unit for deactivating the electric appliance when the electric appliance enters the predetermined status.

5. The communications system of claim 1 wherein the detector is a timer for measuring a working time of the electric appliance.

6. The communications system of claim 1 wherein the detector is a sound detector for detecting sounds from the electric appliance.

7. The communications system of claim 1 wherein the detector is a thermal detector for detecting temperature of the electric appliance.

8. The communications system of claim 1 wherein the communications module is a Bluetooth module.

9. A method for generating a first wireless signal according to a status of an electric appliance, comprising:
(a) detecting the status of the electric appliance;
(b) generating a first warning signal when detecting the status of the electric appliance as a predetermined status;
(c) modulating the first warning signal generated in step (b) to generate the first wireless signal; and
(d) transmitting the first wireless signal generated in step (c).

10. The method of claim 9 further comprising displaying the status of the electric appliance on a display.

11. The method of claim 9 further comprising temporarily storing the first warning signal generated in step (b).

12. The method of claim 9 further comprising deactivating the electric appliance when the electric appliance enters the predetermined status.

13. The method of claim 9 wherein step (a) comprises measuring the working time of the electric appliance.

14. The method of claim 9 wherein step (a) comprises detecting sounds of the electric appliance.

15. The method of claim 9 wherein step (a) comprises detecting the temperature of the electric appliance.

16. The method of claim 9 further comprising receiving an acknowledgement signal from a user after transmitting the first wireless signal.

17. The method of claim 16 further comprising generating a response signal to the user after receiving the acknowledgement signal.

18. The method of claim 9 further comprising:
(e) starting a timer when detecting the status of the electric appliance being a predetermined status.

19. The method of claim 18 further comprising:
detecting if the time in step (e) is over a predetermined time;
generating a second warning signal when the time in step (e) is over the predetermined time; and
modulating the second warning signal and transmitting a second wireless signal generated from modulating the second warning signal.

20. The method of claim 9 wherein step (c) is modulating the first warning signal generated in step (b) for generating a Bluetooth signal.
